(19) United States
(12) Patent Application Publication
(10) Pub. No.: US 2008/0237025 A1
(43) Pub. Date: Oct. 2, 2008

(54) CLOSE-COUPLED VAPOR-COMPRESSION DISTILLER

(76) Inventor: William H. Zebuhr, Nashua, NH (US)

Correspondence Address: FOLEY HOAG, LLP;PATENT GROUP, WORLD TRADE CENTER WEST, 155 SEAPORT BLVD, BOSTON, MA, 02110, US

(21) Appl. No.: 11/691,211

(22) Filed: Mar. 26, 2007

(51) Int. Cl. B01D 5/00

(52) U.S. Cl. 202/172

(57) ABSTRACT

A distiller that employs a rotary heat exchanger uses a centrifugal compressor to impose a pressure difference between the distiller's evaporation and condensation chambers. The compressor's diffuser is provided on the rotary heat exchanger to rotate with it, and the force applied to the diffuser by the vapor that the diffuser slows helps drive the rotary heat exchanger's rotation. Additionally, the compressor is so closely coupled to the heat exchanger that the vapor speed at the condensation chamber's entrance is at least an eighth of the peak vapor speed in the compressor, and the entrance area can therefore be small enough to simplify the task of sealing it.

### BACKGROUND OF THE INVENTION

1. Field of the Invention

The present invention is directed to distillation.

2. Background Information

Distillation is a method of purifying a liquid (such as water) or, conversely, producing a concentrate (such as concentrated orange juice). In distillation, feed liquid to be distilled is heated to the point of evaporation, and the resulting vapor (e.g., steam) is collected and condensed. Distillation is the “gold standard” for water purification, but routine use of distilled water has been limited. Water's heat of vaporization for water being what it is, the more-straightforward approaches tend to be energy intensive. Although the heat that goes into evaporation can be recovered during condensation, the resultant size and complexity of the distillation apparatus has tended to make small-scale distillation impractical for most applications.

But efforts at reducing this barrier have made significant headway, as is evidenced by the devices described in U.S. Pat. Nos. 6,238,524 and 6,261,419 for a Rotating-Plate Heat Exchanger, 6,328,536 for a Reciprocating Low-Pressure-Ratio Compressor, 6,592,338 for a Rotating Compressor, 6,86,387 for a Rotating Fluid Evaporator and Condenser, and 6,908,533 for a Rotating Heat Exchanger. Although the features to which those patents are directed differ, the embodiments they illustrate all have three principal features. The first is that they spin their heat exchangers so that centrifugal force reduces water-film thickness and thereby speeds heat transfer. The second is that they use compressors to make the dew points in their condensation chambers exceed those in their evaporation chambers so that walls that divide the evaporation chambers from the condensation chambers conduct heat from the condensing vapor to the evaporating liquid: the heat of evaporation is recycled.

The third feature is that their compressors are of the positive-displacement variety. Such compressors tend to be relatively efficient for very-low-volume applications, and, although they become less efficient than dynamic compressors with increases in volume, application of dynamic compressors to distillers that use rotary heat exchangers has presented practical complexities.

### SUMMARY OF THE INVENTION

I have developed ways of so replacing the positive-displacement compressor with dynamic compressors as to take advantage in practice of the higher efficiencies and lower cost that such compressors offer. I do this by coupling the compressor closely to the heat exchanger.

One way to do this is to couple the compressor to the heat exchanger in such a manner that the vapor speed at the condensation-chamber's entrance is at least an eighth, and preferably more than a sixth, of the vapor's peak speed in the dynamic compressor. It turns out that this permits the condensation chamber's entrance area to be made small enough to simplify the task of sealing the entrance from the evaporation chamber or other regions to which the vapor might otherwise escape

Another way of performing close coupling is to provide the dynamic compressor's diffuser on the rotating heat exchanger itself so that the diffuser spins with the heat exchanger. This eliminates the requirement for a rotating seal, which is a source of complication that would otherwise attend use of dynamic compression in a rotating-heat-exchanger. Moreover, the diffuser can be arranged in such a way that the vapor's force on the diffuser helps propel the rotating heat exchanger.

### BRIEF DESCRIPTION OF THE DRAWINGS

FIG. 1 is an isometric view of a one type of distiller that can employ the present invention's teachings.

FIG. 2 is an isometric view of the distiller's compressor/rotary-heat-exchanger assembly.

FIGS. 3A-D (together, “FIG. 3”) form a mostly cross-sectional view of that distiller's compressor/rotary-heat-exchanger assembly.

FIG. 4 is an exploded view of two of the distiller's heat-exchanger blades together with their mounting-frame members.

FIG. 5 is a perspective view of some of the heat-exchanger blades mounted in the frame members.

FIG. 6 is a perspective view of the distiller's motor and drive train with parts broken away.

FIG. 7 is a detailed view of a portion of FIG. 3C in which a sprayer orifice is located.

FIG. 8 is an elevation of several abutting heat-exchanger blades in the orientations they assume when they are mounted in their frame.

FIG. 9 is a detail of FIG. 8's upper portion.

FIG. 10 is a detail of FIG. 8's lower portion.

FIG. 11 is a perspective view of the distiller with parts removed to show a portion of the rotary heat exchanger together with one of the stationary scoops that feed it.

FIG. 12 is a perspective view, with parts broken away, of the distiller's condensate-collection chamber and adjacent components.

FIG. 13 is a diagram showing the relative radial positions of the distiller's vapor propeller, compressor impeller, compressor diffuser, and heat-exchanger-blade inlets.

FIG. 14 is a cross-sectional view of a heat-exchanger blade taken at line 14-14 of FIG. 4.

FIG. 15 is a cross-sectional view of a plurality of heat-exchanger blades taken at line 15-15 of FIG. 4.

FIG. 16 is a cross section similar to FIG. 3B but taken through a different pair of heat-exchanger blades, to one of which a sealing ring provides condensate outlets.

FIG. 17 is a detail of a portion of FIG. 3B that includes a cross section of one of the condensate-propeller blades.

FIG. 18 is a perspective view of a seal retainer and a portion of the distiller's motor shaft where its condensate impeller is mounted, together with a cross-sectional view of the distiller's stationary hollow axle.

FIG. 19 is a perspective view of the hollow axle's upper surface.

FIG. 20 is also a cross section similar to FIG. 3B but taken through a pair of heat-exchanger blades that have been provided with respective vents for non-condensables.

### DETAILED DESCRIPTION OF AN ILLUSTRATIVE EMBODIMENT

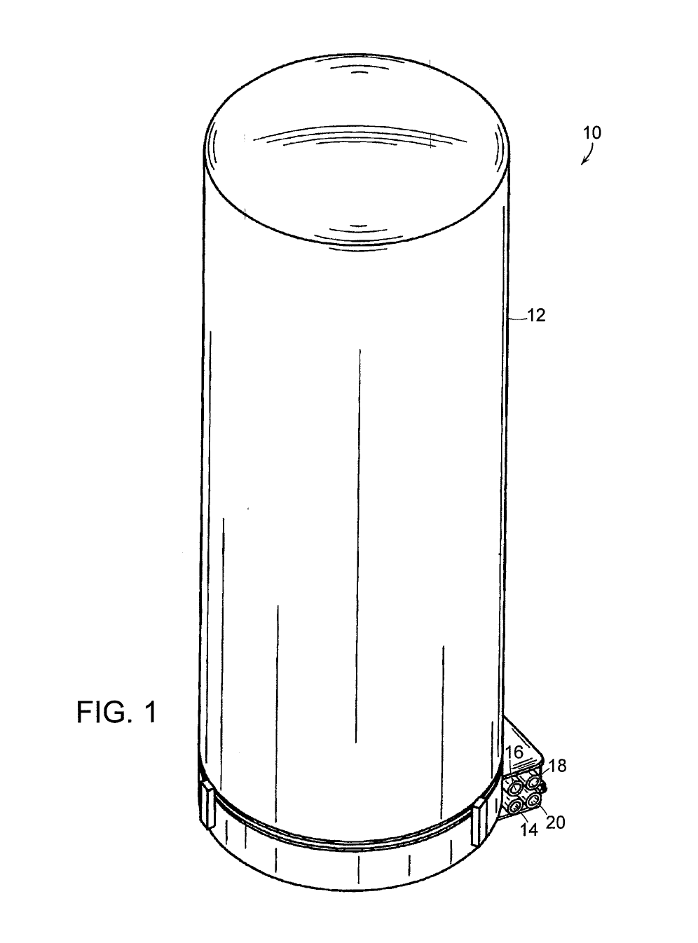

FIG. 1 depicts a distiller 10 enclosed by an insulating jacket 12. Feed liquid to be purified or concentrated enters a feed inlet 14, concentrate leaves through a concentrate outlet 16, condensate leaves through a condensate outlet 18, and volatile impurities are vented through a vent outlet 20.

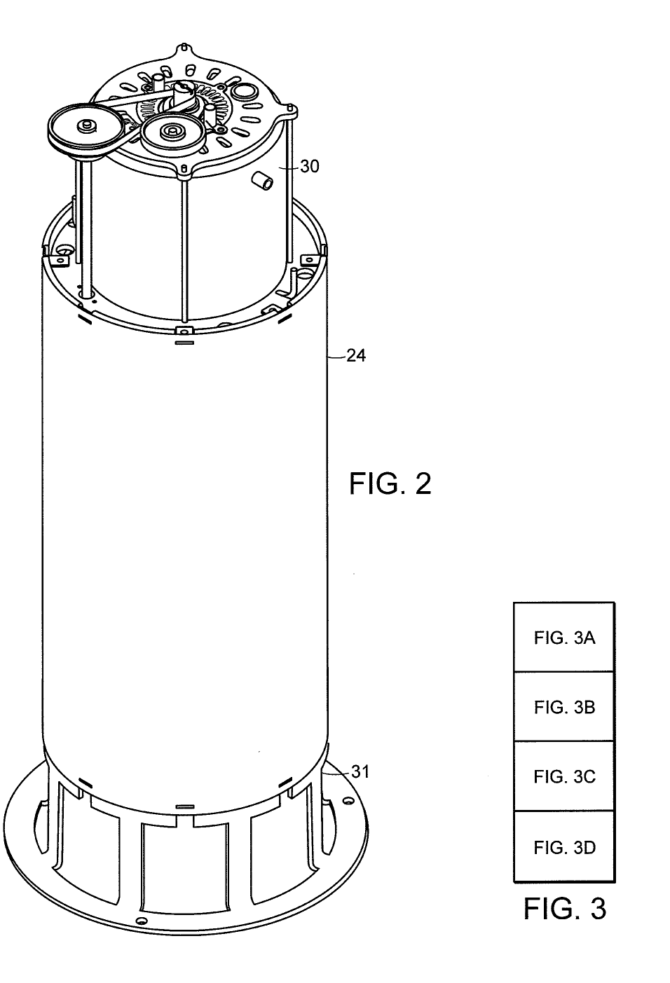

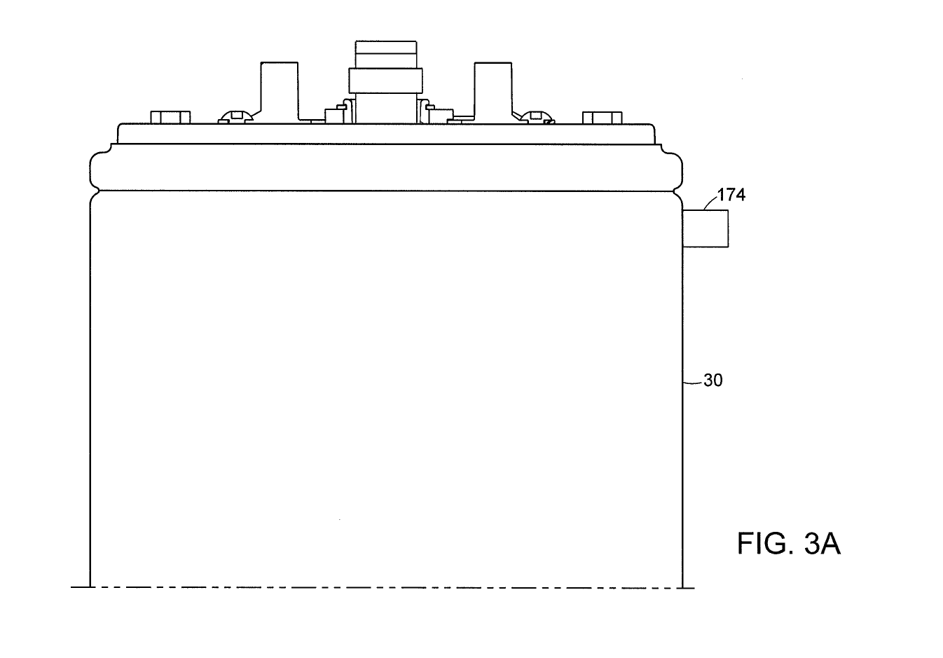

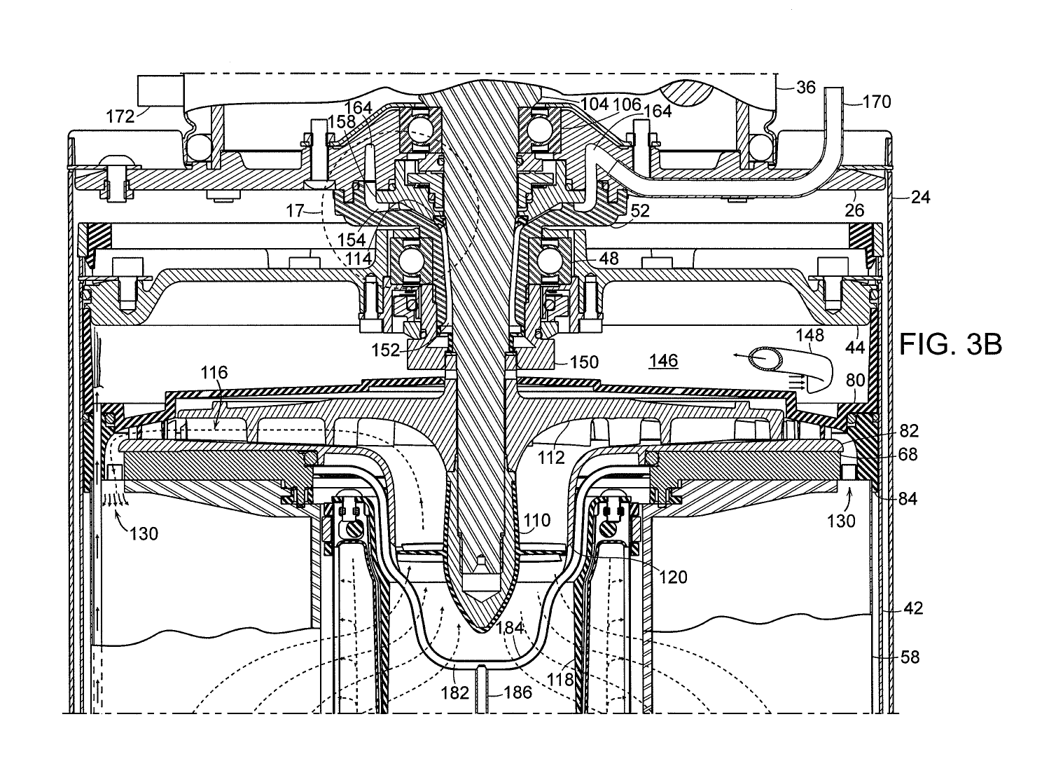

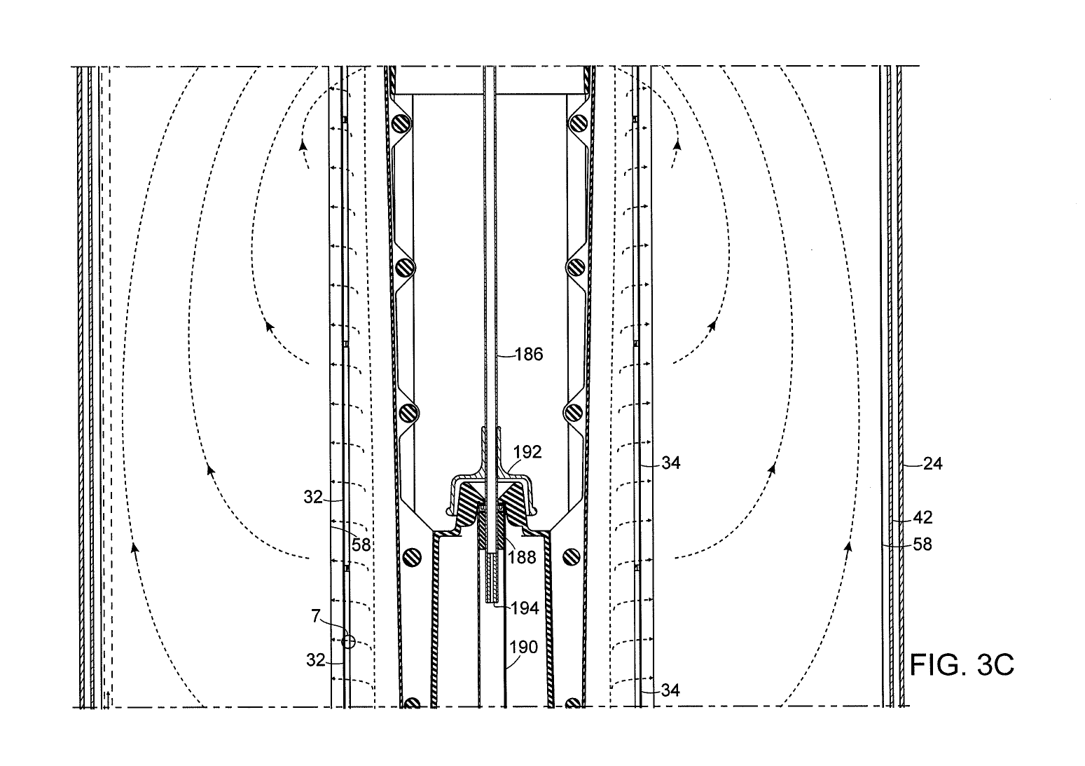

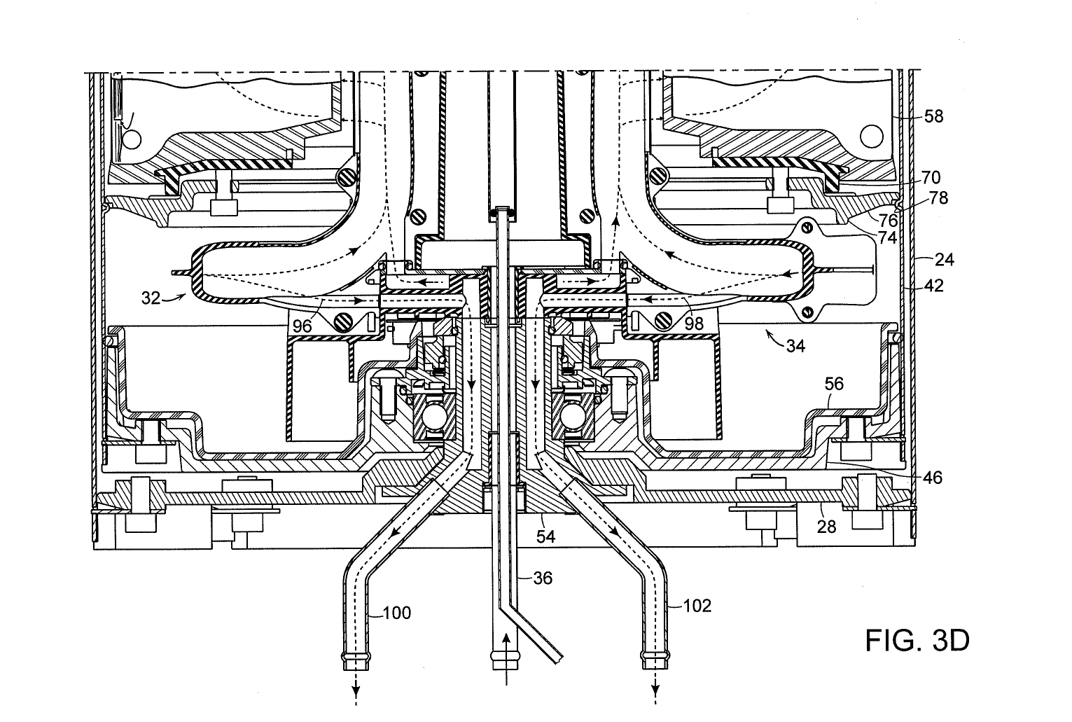

In addition to a counterflow heat exchanger, pump, and control circuitry omitted from the drawings, the insulating jacket encloses a compressor/rotary-heat-exchanger assembly of which FIG. 2 is an isometric view and FIG. 3 is mostly a simplified vertical cross section. That assembly can be thought of as divided into three subassemblies characterized by respective different rotational speeds. Part of the first, stationary subassembly is made up of a generally cylindrical shell that comprises an external cylindrical side wall 24 (FIG. 3B) capped by a top end wall 26 and, as FIG. 3D shows, a bottom end wall 28. A motor 30 (FIG. 3A) for driving the system's other two subassemblies is mounted on the top end wall, and the bottom end wall is mounted on a platform identified in FIG. 2 by reference numeral 31. That platform also supports sprayer/scoop-tube assemblies, identified by FIG. 3D's reference numerals 32 and 34, that are located in the distiller's evaporation chamber.

At the bottom of FIG. 3D can be seen an inlet conduit 36. Together with a complementarily positioned inlet conduit not shown in the drawings, inlet conduit 36 supplies the sprayer/scoop-tube assemblies 32 and 34 feed liquid that a pump and counterflow heat exchanger, also not shown, draw from FIG. 1's feed inlet 14 and heat nearly to the dew point that prevails in the evaporation chamber. For the sake of concreteness, we will assume that the feed liquid is water to be purified, but those skilled in the art will recognize that the present invention's teachings can be applied to other distillation applications; for example, the feed liquid could be orange juice to be concentrated.

In contrast to the first subassembly, the second and third subassemblies both spin, the third much faster than the second. As can be seen in FIGS. 3B and 3D, part of the second subassembly is a rotating fluid enclosure comprising a cylindrical-sump-forming rotating-can wall 42 capped by upper and lower end walls 44 (FIG. 3B) and 46 (FIG. 3D) journaled by respective bearing assemblies 48 (FIG. 3B) and 50 (FIG. 3D) onto respective stationary hollow shafts 52 (FIG. 3B) and 54 (FIG. 3D) respectively secured to the stationary shell's upper and lower end walls 26 and 28. A corrosion-resistant ethylene chloro-trifluoroethylene cover plate 56 shown in FIG. 3D protects the lower wall and bearing assembly because water collects on the bottom of the second rotating assembly's interior when that second assembly not rotating.

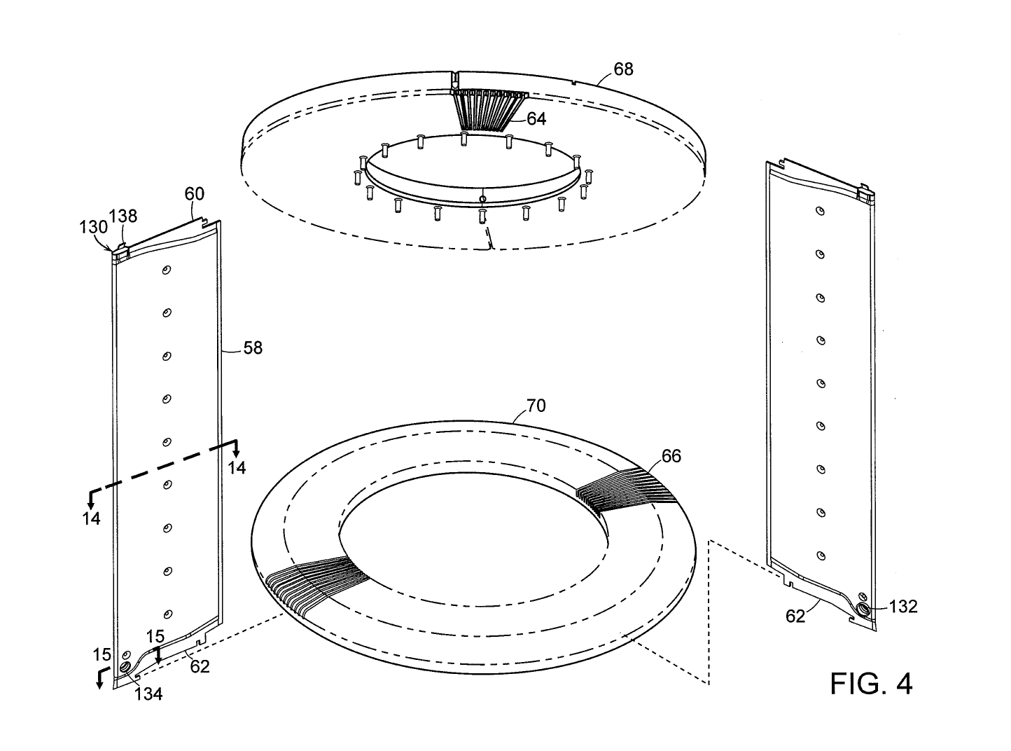

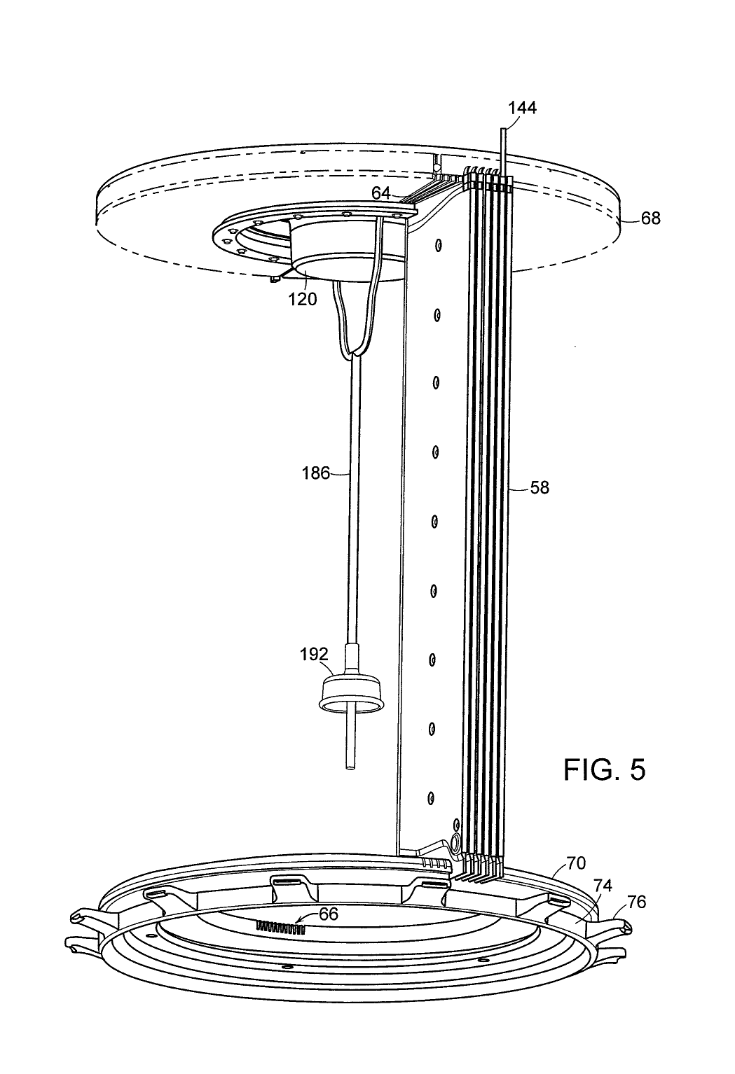

The heart of the second subassembly is its heat-exchanger surfaces, which a group of 210 radially extending heat-exchanger blades 58 provides. FIGS. 4 and 5 show that those blades' upper and lower tabs 60 and 62 fit in slots 64 and 66 formed by upper and lower frame plates 68 and 70. As FIG. 5 shows, the lower frame plate 70 rests on a lower heat-exchanger mounting ring 74. That ring forms radially extending tabs 76 supported, as FIG. 3D shows, by dimples 78. As FIG. 3B shows, a chamber-dividing wall 80 secured to the rotating-can wall 42 by the second subassembly's end wall 44 holds the upper frame plate 68 and blades 58 in place from above through a compression-chamber entrance funnel 82 and an upper heat-exchanger mounting ring 84.

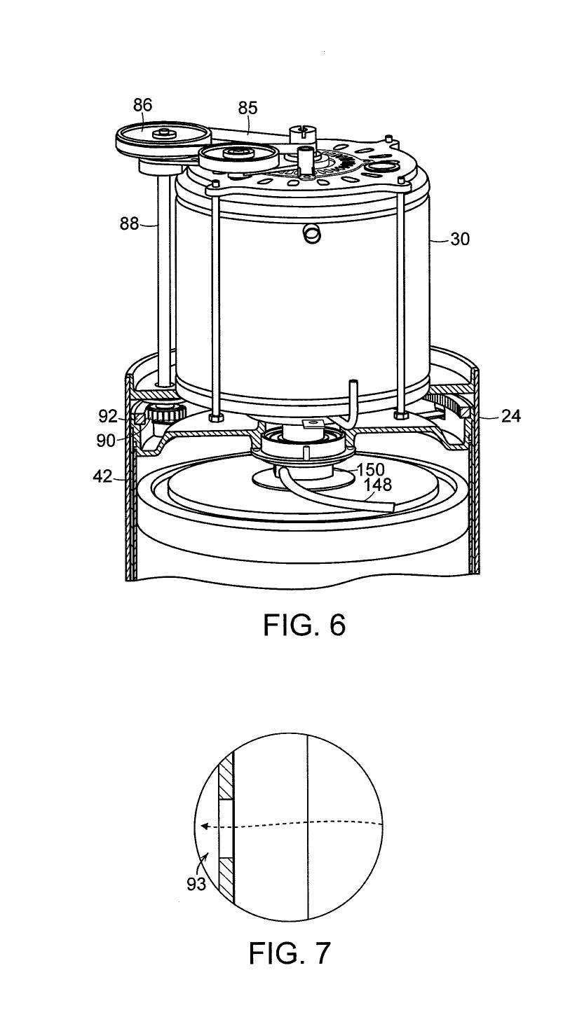

As FIG. 6 shows, the motor 30 drives this entire second subassembly through a drive train that includes a belt 85 by which the motor 30 drives a pulley 86 mounted on a shaft 88. A pinion 90 also mounted on shaft 88 drives a ring gear 92 mounted on the interior wall of the second, heat-exchanger-containing assembly's rotating-can wall 42. In the illustrated embodiment, that assembly's resultant rotational speed varies but is typically on the order of 600-700 RPM (68-73 rad/sec.).

As can be seen in FIG. 3C, the sprayers 32 and 34 spray the feed water outward from their openings (of which one is identified in FIG. 7 by reference numeral 93) to the heat-exchanger blades 58, which are heated from inside, as will be described below in more detail. Together with the second assembly's rotating-can walls 42, 44, and 46, the heat-exchanger blades' external surfaces define the distiller's evaporation chamber. Although the blades' interior temperature in the illustrated embodiment typically exceeds the evaporation chamber's dew point by less than 3°, the rate of heat transfer is relatively high not only because the blade walls are thin and thermally conductive but also because the centrifugal force that results from the heat exchanger's rotation acts against surface tension to keep the sprayer-caused liquid film on the blade surfaces very thin. As a consequence, a significant portion of that film evaporates.

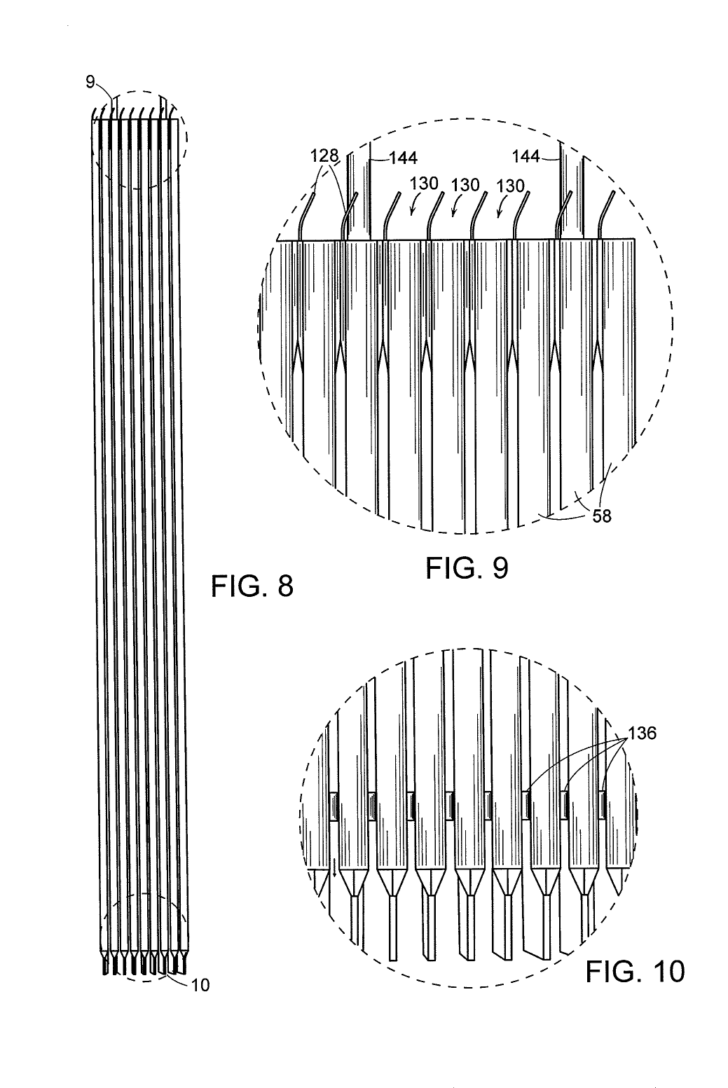

But most of it does not, and the liquid that does not evaporate flows through inter-blade spaces best seen in FIGS. 8, 9, and 10 to collect in an annular sump formed by the rotating-can wall 42's inner surface. To direct the sump liquid back into the sprayers, the stationary subassembly's sprayer assemblies form respective feed-liquid scoops, of which FIG. 11's reference numeral 94 identifies one. These feed-liquid scoops skim the sump liquid, and that liquid's kinetic energy carries it back up the sprayers and again onto the blades' outer surfaces.

Since contaminants tend not to evaporate, this recirculation tends to concentrate them in the rotating sump. The degree of concentration is limited by the fact that some of this skimmed liquid bleeds off, as FIG. 3D shows, through concentrate paths 96 and 98 to conduits 100 and 102. Those conduits lead to the counterflow heat exchanger, where the concentrate surrenders some of its heat to the incoming feed liquid. Concentrate thus cooled is discharged through FIG. 1's concentrate outlet 16.

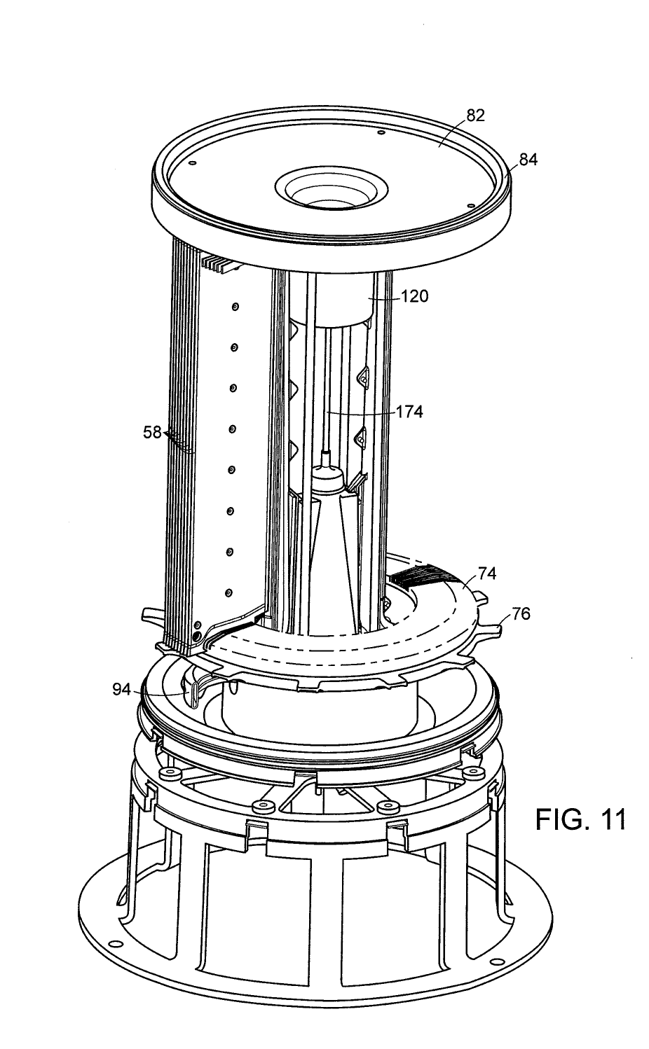

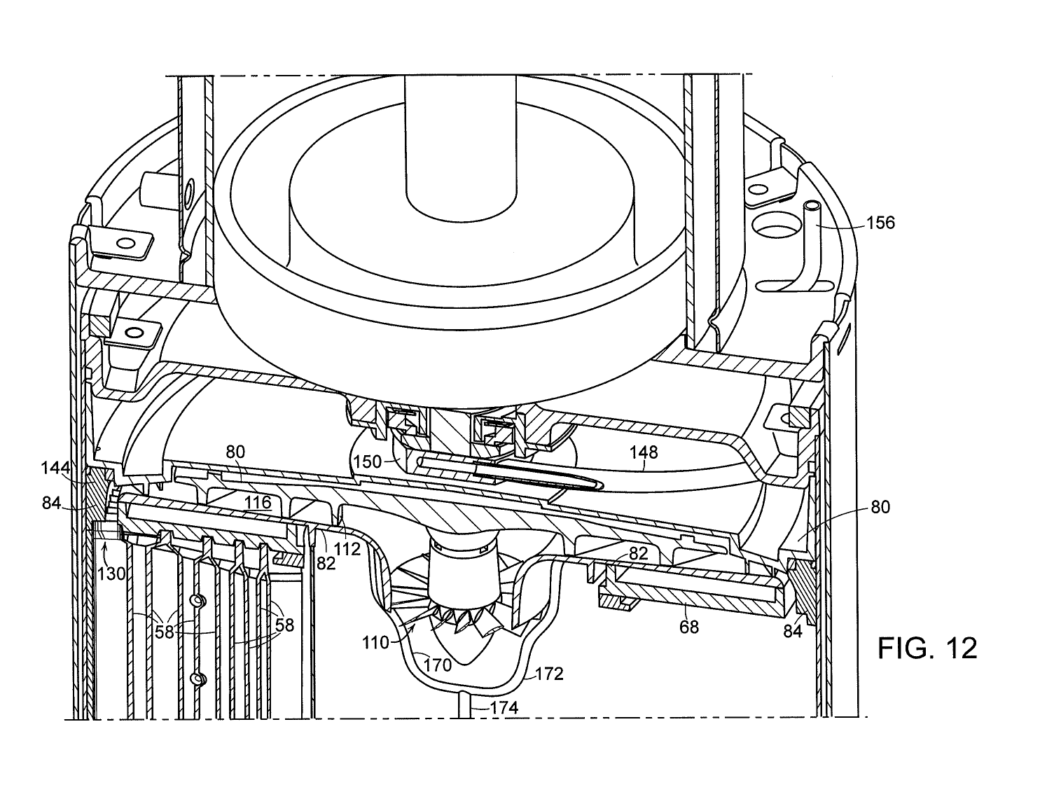

As was stated above, a small but significant portion of the sprayed liquid evaporates, and it is the third subassembly that receives with the resultant vapor, which is almost pure water vapor in the example. Whereas the second subassembly spins at 600-700 RPM, the third subassembly spins much faster, at the motor's 18,000 RPM (1885 rad./sec.) speed. As FIG. 3B shows, the motor shaft 104 is journaled in the stationary top end wall 26 by a bearing assembly 106. Secured to the motor shaft 104 are a vapor propeller 110, a compressor impeller 112, and a condensate impeller 114. The vapor propeller 110, which FIG. 12 shows best, cooperates with the compressor impeller 112 to draw vapor from the evaporation chamber into a compression chamber 116 (FIG. 3B) that the rotating can 42 cooperates with the chamber-dividing wall 80 and the compressor inlet funnel 82 to form. In doing so, it performs a separation function by flinging outward any liquid droplets that may be entrained in the vapor, driving them onto a stationary droplet trap 118 so that they are excluded from the compressor chamber 116 by the compressor inlet funnel 82's mouth portion 120 and are guided back to the heat-exchanger blades over the trap 118's upper rim.

In contrast to the thus-excluded liquid, almost all the vapor reaches the compressor chamber 116, where the rapidly spinning compressor impeller 112 acts upon it. As FIG. 13 shows, the impeller's depending spiral arms 124 are shaped to accelerate the vapor tangentially and outward. The resultant high-tangential-velocity vapor, whose speed in the illustrated embodiment reaches around 400 ft/sec. (122 m/sec.), then encounters diffuser blades 126 formed on the chamber-dividing wall 80's lower surface, which rotates only as fast as the heat exchanger. The diffuser blades act to slow the vapor in a manner that results in relatively low turbulence. They thereby perform much of the conversion of dynamic pressure to the static pressure that it is the compressor's purpose to impart, after which blade-tab ears 128 (FIG. 4) deflect the thus-compressed vapor downward into small openings 130 formed at the outer ends of the blades' top surfaces. Those openings serve both as the compressor's outlet and as the condensation chamber's inlet.

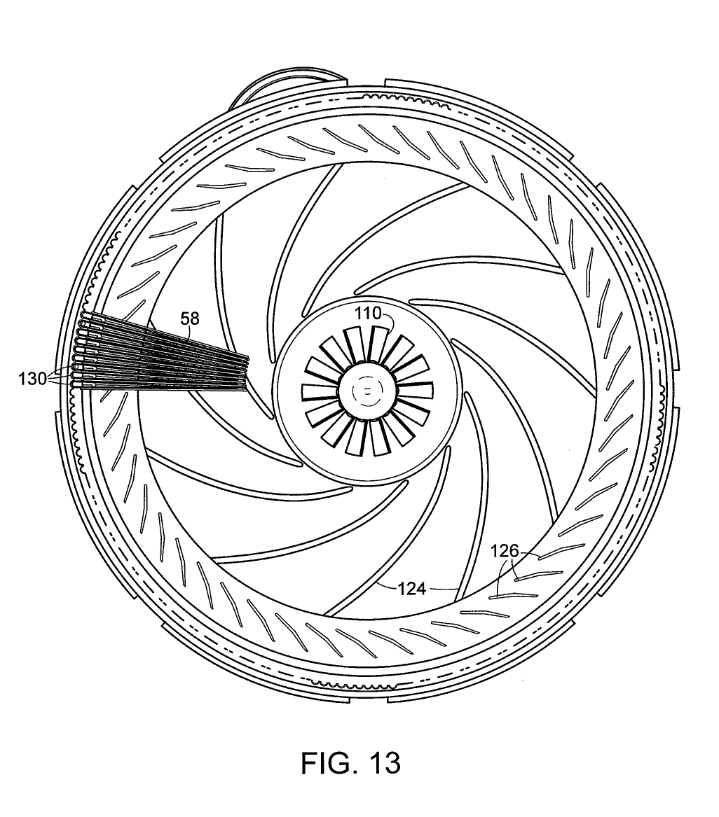

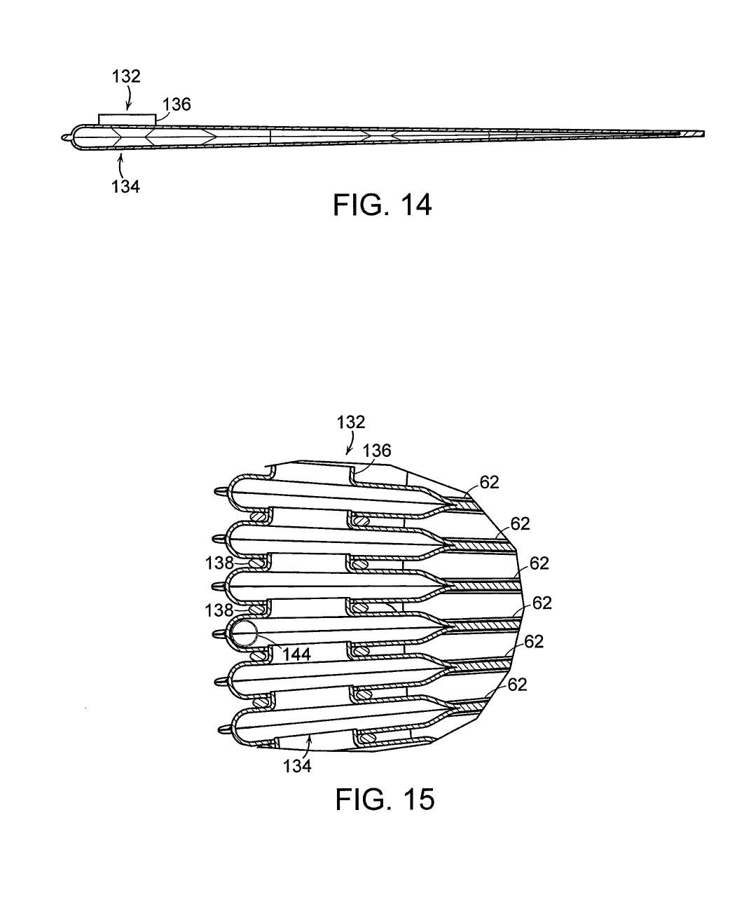

We digress here briefly to consider FIG. 14, which is a cross section taken at line 14-14 of FIG. 4. Except in the end-tab regions, where the walls are crimped together, the blades are hollow, and the resultant interior condensation chambers are slightly wedge-shaped. As FIG. 4 shows, each upper blade tab's lower edge inclines downward away from the opening in such a manner that the cross-sectional blade-cavity area seen by the entering vapor increases rapidly but not discontinuously. Each blade's interior is completely closed except for (1) the above-mentioned blade opening 130 formed on the blade's upper end and (2) complementary inter-blade-communication openings 132 and 134 formed near the blade's bottom outer corner. As FIG. 14 shows, each blade forms a circular, outward-extending lip 136 around inter-blade-communication opening 132.

During assembly, adjacent blades are slid inward in FIG. 5's slots 64 and 66, which cam them together circumferentially in such a manner that each blade's lip 136 mates with its neighbor's complementary opening 134, as FIG. 15 shows, to form an inter-blade passage that an O-ring 138 mounted on the lip 136 seals. Therefore, openings 132 and 134 provide communication among the blades' interiors to form a composite condensation chamber, but they provide no way out of that condensation chamber; in the illustrated embodiment, fluid can enter or leave that chamber only through the relatively small upper openings identified in FIG. 4 by reference numerals 130.

Note that the compressor's “stator,” i.e., the diffuser blades identified by reference numeral 126 in FIG. 13, are not really stationary, as they would be in a conventional compressor; they are mounted on the rotary heat exchanger and therefore rotate with it. A consequence is that the system does not need a rotary seal between the compressor outlet and the rotating heat exchanger is necessary. Also, the blades' orientations are such that the reaction force caused by the vapor's impinging on them assists in driving the rotary heat exchanger. Indeed, although the drive train depicted in FIG. 6 was described as driving the rotary heat exchanger, most if not all of the driving actually results from that diffuser-blade reaction: the principal coupling between the motor and the rotary heat exchanger occurs pneumatically, through the compressor. One result is that much of the frictional loss that would otherwise occur in the FIG. 6 rotary-heat-exchanger drive train is eliminated. Some embodiments may in fact dispense entirely with a separate drive train such as that of FIG. 6; it turns out that the resultant rotary-heat-exchanger speed would tend to remain stably in a fairly narrow range.

Although the diffuser blades greatly reduce the vapor's speed and therefore increase its static pressure, a significant remnant of the vapor speed remains when the vapor thereafter enters the condensation chambers through FIG. 4's heat-exchanger-blade openings 130. To appreciate this, consider that the number of blades in the illustrated embodiment is 210 and that a single blade's cross-sectional area below its upper tab is 0.09 in² (0.6 cm²), so the total condensation-chamber cross-sectional area is 18.9 in² (122 cm²). If, as is typical, the rate of vapor flow from the compressor is on the order of 100 cubic feet per minute (0.047 m³/sec.), the vapor speed just below the bottoms of the blades' upper tabs 60, where the vapor path has first reached its maximum area but little vapor has yet condensed, is about 12 feet per second (3.7 m/sec.). But the total area of the blade openings 130, which together can be thought of as a composite entrance to the composite condensation chamber, is only 2.3 in² (15 cm²), i.e., only 12% of the maximum path area inside the condensation chamber, so the typical speed at the blade entrance is much higher, say, 100 ft/sec. (30 m/sec.). This means that some of the conversion from dynamic to static pressure remains to be done as the vapor enters the condensation chamber: a small but not significant amount of the compression is still occurring in the condensation chamber just beyond its entrance.

Such close coupling of the compression and condensation operations enables sealing to be simplified further. To appreciate this, recall that distillation efficiency requires a large heat-transfer surface area. To that end the illustrated, hollow-blade approach is like many others; the vapor's flow over the heat-exchange surfaces is very “parallel” in the sense that the overall width of the vapor path along those surfaces is large in comparison to the average length of the vapor's flow along that path. In the case of the illustrated embodiment, for example, the path width is about two orders of magnitude higher than the average path distance.

Now, such parallelism could complicate assembly because the condensation chamber needs to be sealed from the evaporation chamber, and the high degree of parallelism would ordinarily necessitate sealing over a great length of condensation-chamber-entrance perimeter. But closely coupling the compression and condensation operations mitigates that problem. As the drawings illustrate, each blade's entrance opening is quite small, and this smallness is possible because, as was stated above, the compression operation is still somewhat incomplete at the entrance: the vapor's speed is still a significant fraction of its maximum speed in the compressor.

If the compression were instead substantially complete at the entrance and the vapor speed were therefore as slow as it becomes after the vapor has entered very far into the condensation chamber, the entrance-opening area would have had to be much greater, and that would have lengthened the entrance perimeter greatly. In the illustrated, blade-type arrangement, for example, seals would probably have to be provided along the blades' entire radial extent. But close coupling enables the sealing to be limited to only a compact region near the blades' outer ends. And that compactness contributes further to reducing sealing requirements, because it reduces the ratio of sealing length to entrance area.

Indeed, the sealing approach used in the illustrated embodiment is particularly simple. As FIG. 3B shows, the exit from the compressor chamber 116 is restricted to an annular region between the outer periphery of funnel 82's upper surface and the inner edge of the mounting ring 84's upper surface. Not only does this tend to direct the vapor into heat-exchanger-blade openings 130, but, as FIG. 9 shows, the heat-exchanger blades 58 abut each other in the opening-130 region to provide metal-to-metal seals. So, to the extent that any sealant is needed at all, it is required only where the opening-130 edges meet the funnel 82 or the ring 84.

Of course, the benefits of close coupling can be obtained in arrangements whose design parameters depart significantly from the illustrated embodiment's. Still, the sealing benefits mentioned above are best obtained if the vapor speed at the condensation chamber's entrance is at least an eighth as high as the speed to which the compressor has accelerated the vapor, and I prefer for that entrance speed to be more than a sixth as high; it is about a quarter as high in the illustrated embodiment.

Because of the compressor, the pressure in the heat-exchanger blades' interiors exceeds the exterior vapor pressure, and the resultant elevated dew point exceeds the temperature that prevails on the blades' exterior surfaces. So heat flows from condensing water in the blades' interior, condensation chambers to the liquid film on the blades' exterior surfaces. This is what drives the evaporation mentioned above.

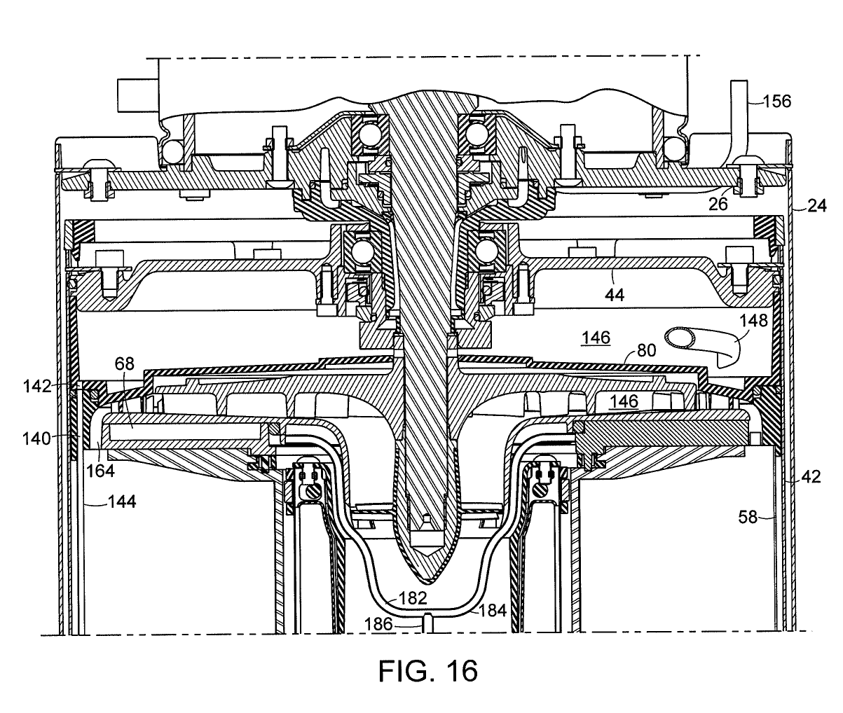

The liquid that has thus condensed is driven by centrifugal force to the blade interiors' radially outward edges. As can perhaps be seen best on the left side of FIG. 12, the heat-exchanger mounting ring 84 so seals the radially outer portions of most blades' entrance openings 130 that, although vapor can enter those openings, liquid cannot leave it, because centrifugal force confines the liquid to a thin elongated bead that the mounting ring 84 blocks. In every fifth blade, though, the arrangement is different, as the left side of FIG. 16 shows. In registration with every fifth blade, the mounting ring 84 and dividing wall 80 form respective condensate-exit bores 140 and 142 through which a condensate tube 144 extends from the bottom of that fifth blade's interior to a condensate chamber 146 that the spinning can 42 cooperates with upper wall 44 and chamber-dividing wall 80 to define. The only fluid paths from the blades' interiors to the condensate-collection chamber 146 include the bottom ends of the condensate tubes. Those ends are usually submerged in respective axially extending beads of collected condensate, which thereby prevent vapor from reaching the condensate-collection chamber without condensing. Even when not enough condensate has yet accumulated to submerge the tubes' lower ends, though, the tubes' high flow resistance prevents much vapor from escaping through that route.

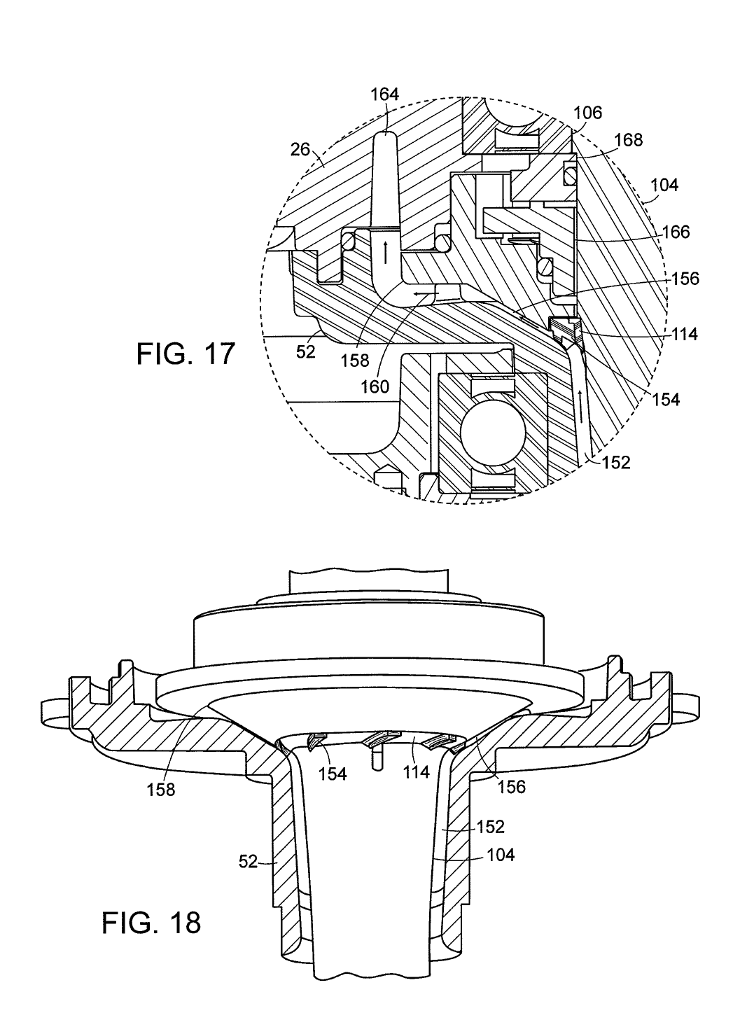

The condensate that has thus reached the condensate-collection chamber 146 and by centrifugal force formed an annular condensate ring on that chamber's circumferential wall is skimmed by a stationary condensate scoop tube identified in FIG. 6 by reference numeral 148. Scoop tube 148 is an extension of a fitting 150 that, as FIG. 3B shows, is mounted on the stationary hollow axle 52. Scoop tube 148 provides fluid communication between its scoop mouth and a generally annular passage 152 that fitting 150 and axle 52 cooperate with the motor shaft 104 to form. The condensate retains much of its annular momentum, swirling circumferentially about that passage as it travels upward, and that rotation is enhanced by the condensate impeller 114, which FIGS. 17 and 18 show in more detail.

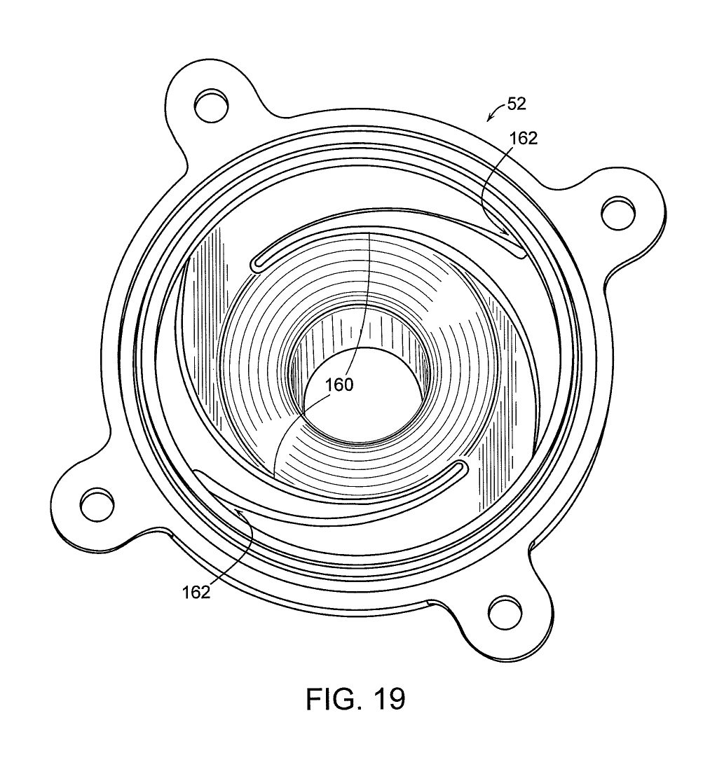

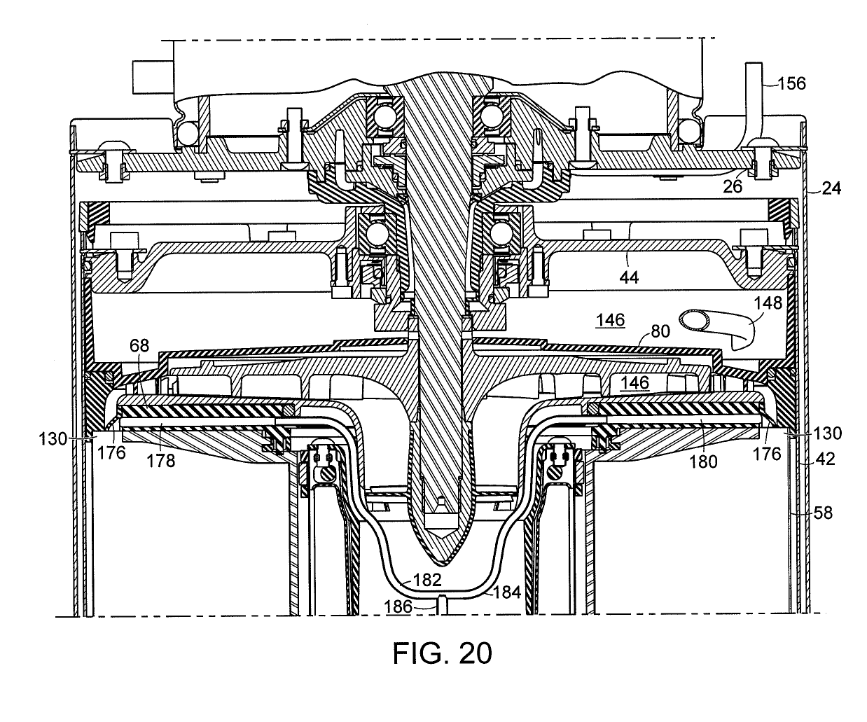

As was stated above, that impeller is mounted on the motor shaft 104 and rotates with it. Its blades 154 drive the condensate up a conical condensate-path extension 156 that the stationary axle 52 cooperates with a stationary seal retainer 158 to define. As FIG. 19 shows, the stationary axle 52's upper surface forms raised spiral guides 160 that, as a result of the condensate's clockwise rotation, direct the condensate into corners 162 and thereby drive it upward, as FIG. 17 shows, into a generally annular bearing-coolant chamber 164 formed in the stationary top wall 26. There the condensate absorbs heat from that wall, which tends to be heated by conduction of friction-generated heat from bearing 106 and from a high-speed seal formed between a stationary carbon member 166 and a hardened ring 168 that rotates with the motor shaft 104.

As FIG. 3B shows, condensate thus heated leaves the coolant chamber 164 through a tube 170. That tube leads to the counterflow heat exchanger, where the condensate flowing through it surrenders much of its heat to the incoming feed liquid before it leaves the distiller through the condensate outlet that FIG. 1's reference numeral 18 identifies. As was mentioned above, the feed water is heated in the counterflow heat exchanger not only by this purified condensate but also by the impurities-containing concentrate. Before being supplied to the sprayers, moreover, the feed water from the counterflow heat exchanger flows by way of a jacket inlet conduit identified in FIG. 3B by reference numeral 172, through a motor-cooling jacket. There it absorbs further heat and then flows by way of FIG. 3A's jacket outlet conduit 174 and FIG. 3D's conduit 36 to the sprayers 32 and 34. In steady-state operation the feed liquid thereby supplied the sprayers is hot enough to produce the desired rate of evaporation, but a start-up heater not shown may be used during a cold start.

As was stated above, the overall principle on which this water distillation relies is that the water itself evaporates but impurities do not, so the condensed vapor is purified water. But the feed water sometimes includes a small amount of volatile impurities even though in an operation not shown it will typically have been de-gassed before being fed to the sprayer. Such volatiles get drawn by the compressor from the evaporation chamber along with the water vapor and accompany the water vapor into the condensation chamber. The partial pressures of almost all such impurities are too low for them to condense at the condensation-chamber temperature, so they do not contaminate the purified condensate. But they do tend to accumulate in the condensation chamber, so the condensation chamber need to be vented.

As FIG. 20 shows, the openings 130 in two of the 210 heat-exchanger blades therefore serve not as vapor inlets but instead as outlets for volatile impurities that have accumulated in the other blades. Such impurities will have flowed to FIG. 20's two heat exchanger blades 58 through the inter-blade-communication openings identified in FIG. 15 by reference numerals 132 and 134. To make the outputs of FIG. 20's heat-exchanger blades serve that purpose, volatiles-separation seals 176 keep the vapor in compressor chamber 116 from flowing through openings 130 but allow gas (volatile impurities) to flow through radial passages 178 and 180 provided in the upper heat-exchanger-frame member 68.

Those passages lead into respective arms 182 and 184 of a (rotating) vent tube That vent tube's stem 186 extends, as FIG. 3C shows, through a bushing 188 provided in a stationary extension tube 190, which leads to FIG. 1's vent outlet 20. As FIG. 3C shows, an inverted cup member 192 mounted on the rotating vent tube's stem 186 tends to shield the bushing from sprayed feed water. A flow restrictor 194 disposed in the stem 186 keeps the condensation-chamber vapor pressure from falling too low.

By employing one or more of the close-coupling concepts described above, a dynamic-compressor-type distiller can be made highly efficient and low in cost even in relatively small sizes. The invention therefore constitutes a significant advance in the art.

What is claimed is:

1. A distiller that includes a feed inlet and a condensate outlet and comprises:
A) a heat exchanger that includes a plurality of heat-exchange walls whose opposite faces respectively cooperate with other surfaces to define an evaporation chamber and a condensation chamber;
B) a compressor whose inlet is coupled to the evaporation chamber for drawing vapor therefrom and driving the vapor to a peak vapor speed, the compressor's outlet being in such communication with the condensation chamber that the compressor's output vapor enters the condensation chamber at a speed that exceeds an eighth of the peak vapor speed; and
C) a fluid circuit that includes fluid paths from the feed inlet to the evaporation chamber and from the condensation chamber to the condensate outlet.

2. A distiller as defined in claim 1 wherein:
A) the heat exchanger is a rotary heat exchanger; and
B) the distiller includes a rotary-motion source so coupled to the heat exchanger as to cause the heat exchanger to rotate about a heat-exchanger axis.

3. A distiller as defined in claim 2 wherein the compressor is a dynamic compressor that includes:
A) an impeller that accelerates vapor drawn from the compressor's inlet to an elevated speed; and
B) a diffuser so shaped and positioned with respect to the impeller as to slow the thereby-accelerated vapor in such a manner that the compressor supplies to the condensation chamber vapor whose static pressure exceeds that of the vapor entering the compressor's inlet.

4. A distiller as defined in claim 3 wherein the diffuser is disposed on the rotary heat exchanger for rotation therewith.

5. A distiller as defined in claim 4 wherein the diffuser is so arranged that reaction force resulting from its slowing of the accelerated vapor urges the rotary heat exchanger in the direction in which that heat exchanger is rotating.

6. A distiller as defined in claim 3 wherein the compressor is a centrifugal compressor.

7. A distiller as defined in claim 2 wherein the condensation chamber is a composite condensation chamber that includes a plurality of constituent condensation chambers of which each is defined by the interior surfaces of a hollow heat-exchanger blade whose exterior surfaces cooperate with other walls' surfaces to define the evaporation chamber.

8. A distiller as defined in claim 2 wherein the impeller rotates about the rotary heat exchanger's axis.

9. A distiller as defined in claim 1 wherein the condensation chamber is a composite condensation chamber that includes a plurality of constituent condensation chambers of which each is defined by the interior surfaces of a hollow heat-exchanger blade whose exterior surfaces cooperate with other walls' surfaces to define the evaporation chamber.

10. A distiller that includes a feed inlet and a condensate outlet and comprises:
A) a heat exchanger that includes a plurality of heat-exchange walls whose opposite faces respectively cooperate with other surfaces to define an evaporation chamber and a condensation chamber;
B) a rotary-motion source so coupled to the heat exchanger as to cause it to rotate about a heat-exchanger axis;
C) a dynamic compressor that includes:
i) an inlet coupled to the evaporation chamber for drawing vapor therefrom;
ii) an outlet in such communication with the condensation chamber that the compressor's output vapor enters the condensation chamber;
iii) an impeller that accelerates vapor drawn from the compressor's inlet to an elevated speed; and
iv) a diffuser that is:
a) so shaped and positioned with respect to the impeller as to slow the thereby-accelerated vapor in such a manner that the compressor supplies to the condensation chamber vapor whose static pressure exceeds that of the vapor entering the compressor's inlet; and
b) disposed on the heat exchanger for rotation therewith;
D) a fluid circuit that includes fluid paths from the feed inlet the evaporation chamber and from the condensation chamber to the condensate outlet.

11. A distiller as defined in claim 10 wherein the diffuser is so arranged that reaction force resulting from its slowing of the accelerated vapor urges the heat exchanger in the direction in which the heat exchanger is rotating.

12. A distiller as defined in claim 10 wherein the compressor is a centrifugal compressor.

13. A distiller that includes a feed inlet and a condensate outlet and comprises:
A) a heat exchanger that includes a plurality of heat-exchange walls whose opposite faces respectively cooperate with other surfaces to define:
i) an evaporation chamber; and
ii) a condensation chamber that forms a condensation-chamber entrance;
B) a dynamic compressor whose inlet is coupled to the evaporation chamber for drawing vapor therefrom and whose outlet is coupled to the driving the vapor through the condensation-chamber entrance and along a vapor path in the condensation chamber such that the vapor path's maximum area in the condensation chamber bears a ratio of at least eight to the condensation-chamber entrance's area; and
C) a fluid circuit that includes fluid paths from the feed inlet to the evaporation chamber and from the condensation chamber to the condensate outlet.
